(19) United States
(12) Patent Application Publication
(10) Pub. No.: US 2025/0083094 A1
(43) Pub. Date: Mar. 13, 2025

(54) VOC REMOVAL METHOD

(71) Applicant: Murata Manufacturing Co., Ltd., Nagaokakyo-shi (JP)

(72) Inventors: Yukio SANADA, Nagaokakyo-shi (JP); Teppei KAWAI, Nagaokakyo-shi (JP); Teruhisa SHIBAHARA, Nagaokakyo-shi (JP)

(21) Appl. No.: 18/960,080

(22) Filed: Nov. 26, 2024

Related U.S. Application Data
(63) Continuation of application No. PCT/JP2023/019750, filed on May 26, 2023.

(30) Foreign Application Priority Data
Jun. 3, 2022 (JP) 2022-090693

(51) Int. Cl. B01D 53/06

(52) U.S. Cl. CPC B01D 53/06; B01D 2253/102; B01D 2253/108; B01D 2257/708; B01D 2259/4009; B01D 2259/40096

(57) ABSTRACT

A VOC removal method that includes: adsorbing a VOC contained in a process gas by passing the process gas through an adsorption zone of a VOC adsorption rotor that includes a cellular structure supporting an adsorbent to adsorb a VOC, wherein the cellular structure is made of metal; desorbing the VOC adsorbed in the adsorption zone by heating the cellular structure by passing current through the cellular structure in a desorption zone of the VOC adsorption rotor and passing a gaseous substance through the desorption zone of the VOC adsorption rotor; and cooling the cellular structure heated in the desorption zone in a cooling zone of the VOC adsorption rotor.

### CROSS REFERENCE TO RELATED APPLICATIONS

The present application is a continuation of International application No. PCT/JP2023/019750, filed May 26, 2023, which claims priority to Japanese Patent Application No. 2022-090693, filed Jun. 3, 2022, the entire contents of each of which are incorporated herein by reference.

### TECHNICAL FIELD

The present disclosure relates to a method for removing a VOC contained in a process gas.

### BACKGROUND ART

Known techniques in the related art remove a volatile organic compound (VOC) contained in a process gas by use of a honeycomb VOC adsorption rotor that adsorbs the VOC (refer to Patent Document 1). Such a conventional VOC adsorption rotor has a base made of, for example, a ceramic or glass material, and supports an adsorbent that adsorbs a VOC.

The VOC adsorption rotor has the following zones: an adsorption zone in which a VOC contained in a process gas is adsorbed; a desorption zone through which a heated gaseous substance is passed for desorption of the VOC adsorbed in the adsorption zone; and a cooling zone in which the VOC adsorption rotor heated in the desorption zone is cooled. That is, while the VOC adsorption rotor makes one rotation, VOC adsorption is performed in the adsorption zone, VOC desorption is performed in the desorption zone, and cooling is performed in the cooling zone. Then, VOC adsorption is performed again in the adsorption zone.

Patent Document 1: Japanese Unexamined Patent Application Publication No. 2016-77969

### SUMMARY OF THE DISCLOSURE

With conventional VOC adsorption rotors, in order to desorb a VOC that has been adsorbed in the adsorption zone, a gaseous substance is heated, and the heated gaseous substance is passed through the desorption zone. Such a process does not offer very high energy efficiency for desorbing the VOC, and thus has room for improvement.

The present disclosure is directed to addressing the problem mentioned above. It is accordingly an object of the present disclosure to provide a VOC removal method with which a VOC adsorbed on the VOC adsorption rotor can be desorbed with high energy efficiency.

A VOC removal method according to the present disclosure employs a VOC adsorption rotor. The VOC removal method includes: adsorbing a VOC contained in a process gas by passing the process gas through an adsorption zone of a VOC adsorption rotor that includes a cellular structure supporting an adsorbent to adsorb a VOC, wherein the cellular structure is made of metal; desorbing the VOC adsorbed in the adsorption zone by heating the cellular structure by passing current through the cellular structure in a desorption zone of the VOC adsorption rotor and passing a gaseous substance through the desorption zone of the VOC adsorption rotor; and cooling the cellular structure heated in the desorption zone in a cooling zone of the VOC adsorption rotor.

The VOC removal method according to the present disclosure involves, in the desorption zone, passing current through the cellular structure made of metal and thus generating Joule heat to thereby directly heat the cellular structure. As a result, an adsorbed VOC can be desorbed with high energy efficiency in the desorption zone.

### BRIEF DESCRIPTION OF THE DRAWINGS

FIG. 1 schematically illustrates, in perspective view, a configuration of a VOC removal apparatus, which is an example of an apparatus for implementing a VOC removal method according to an embodiment.

FIG. 2 schematically illustrates, in plan view, a configuration of a VOC adsorption rotor as seen in a direction in which its rotational axis extends.

### DESCRIPTION OF THE PREFERRED EMBODIMENTS

Characteristic features of the present disclosure are described in more specific detail below with reference to its embodiments.

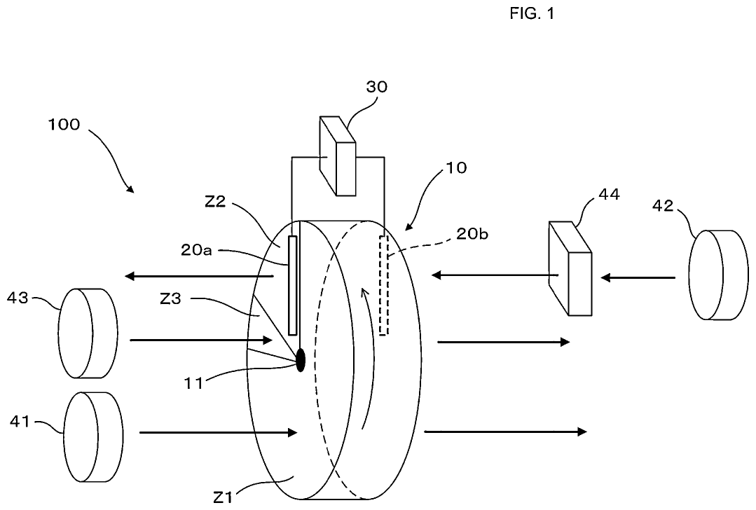

FIG. 1 schematically illustrates, in perspective view, a configuration of a VOC removal apparatus 100, which is an example of an apparatus for implementing a VOC removal method according to an embodiment. It is to be noted, however, that the configuration for implementing the VOC removal method according to an embodiment is not limited to the configuration of the VOC removal apparatus 100 illustrated in FIG. 1.

The VOC removal apparatus 100 includes a VOC adsorption rotor 10, a pair of electrodes 20a and 20b, and a voltage application device 30. As illustrated in FIG. 1, the VOC removal apparatus 100 may further include a first blowing device 41, a second blowing device 42, a third blowing device 43, and a heating device 44.

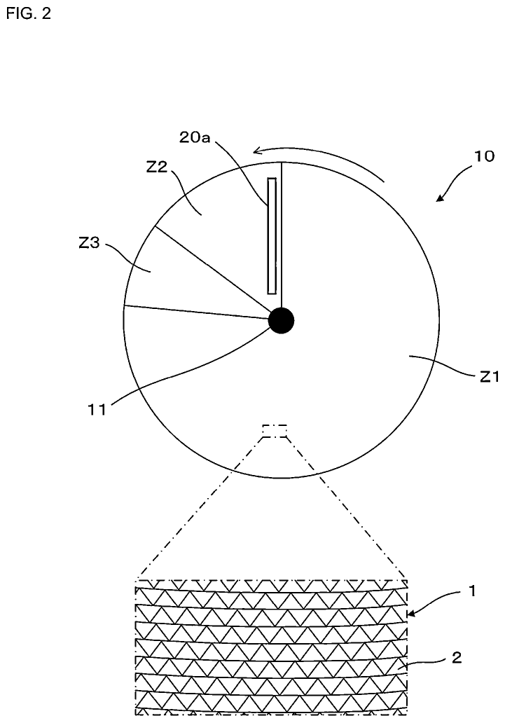

FIG. 2 schematically illustrates, in plan view, a configuration of the VOC adsorption rotor 10 as seen in a direction in which a rotational axis 11 of the VOC adsorption rotor 10 extends (to be also sometimes referred to as “rotational axis direction” hereinafter). It is to be noted, however, that FIG. 2 also depicts the electrode 20a described later. The VOC adsorption rotor 10 is capable of rotating about the rotational axis 11 with a motor or other devices as its drive source. The VOC adsorption rotor 10 has a diameter of, for example, 500 mm to 2000 mm, and has a dimension of, for example, 200 mm to 800 mm in the direction in which the rotational axis 11 extends.

The VOC adsorption rotor 10 includes a cellular structure 1 supporting an adsorbent to adsorb a VOC. The cellular structure 1 is made of metal such as stainless steel. It is to be noted, however, that the metal constituting the cellular structure 1 is not limited to stainless steel. The VOC adsorption rotor 10 may be entirely made of metal, or a portion of the VOC adsorption rotor 10 other than the cellular structure 1 may be made of a material other than a metal.

A plurality of cells 2 constituting the cellular structure 1 may have any shape. In the example in FIG. 2, the cells 2 have a triangular shape as seen in the direction in which the rotational axis 11 extends. The cells 2 may, however, have another shape as seen in the rotational axis direction, such as a hexagonal shape or a rectangular shape.

The adsorbent supported on the cellular structure 1 may be any adsorbent capable of adsorbing a VOC contained in a process gas. Suitable non-limiting examples of the adsorbent include zeolite, activated carbon, and silica. A process gas is, for example, a gas containing a VOC generated in a factory or other places as a result of washing, printing, coating, drying, or other processes. It is to be noted that the kind of the VOC to be removed, or the kind of the adsorbent used does not limit the scope of the present disclosure.

A catalyst for VOC decomposition may be supported on the cellular structure 1. Non-limiting examples of the catalyst for VOC decomposition include platinum and palladium.

As illustrated in FIGS. 1 and 2, the VOC adsorption rotor 10 has an adsorption zone Z1, a desorption zone Z2, and a cooling zone Z3, which are disposed in the direction of rotation. With respect to the direction of rotation, the adsorption zone Z1 occupies an angular range of, for example, 230° to 270°, the desorption zone Z2 occupies an angular range of, for example, 30° to 60°, and the cooling zone Z3 occupies an angular range of, for example, 30° to 60°.

The adsorption zone Z1 is a region through which the process gas is passed for adsorption of a VOC contained in the process gas. According to the embodiment, the process gas is blown by the first blowing device 41.

The desorption zone Z2 is a region for desorbing the VOC adsorbed in the adsorption zone Z1. According to the present disclosure, as will be described later, with the cellular structure 1 heated by passage of current through the cellular structure 1, a gaseous substance is passed through the desorption zone Z2 to desorb the VOC. Although the gaseous substance to be passed through the desorption zone Z2 may be an unheated gaseous substance, using a heated gaseous substance is preferred for more effective VOC desorption. The following description assumes that a heated gaseous substance is to be passed through the desorption zone Z2. That is, in the VOC removal apparatus 100 illustrated in FIG. 1, a gaseous substance blown by the second blowing device 42 is heated by the heating device 44 such as a heater before being delivered to the desorption zone Z2.

The cooling zone Z3 is a region for cooling the cellular structure 1 heated in the desorption zone Z2. According to the embodiment, a gaseous substance for cooling the cellular structure 1 is blown to the cooling zone Z3 by the third blowing device 43.

In another example, a gas that has undergone VOC removal by passing through the adsorption zone Z1 may be returned to the emission source of the process gas. In still another example, a gaseous substance that has been warmed by passing through the cooling zone Z3 may be used as the gaseous substance that is to be passed through the desorption zone Z2.

As the VOC adsorption rotor 10 rotates counterclockwise in FIG. 2, the cells 2 located in the adsorption zone Z1 move to the desorption zone 2 and the cooling zone Z3 in this order before returning to the adsorption zone Z1. At this time, the cellular structure 1 is cooled in the cooling zone Z3, which makes it possible for the cellular structure 1 to adsorb a VOC in the adsorption zone Z1 again.

That is, as the VOC adsorption rotor 10 rotates, adsorption and desorption of a VOC contained in the process gas are performed repeatedly. If a catalyst for VOC decomposition is supported on the cellular structure 1, a VOC decomposition reaction takes place in the desorption zone Z2. Since such VOC decomposition can be regarded as desorption of a previously adsorbed VOC, VOC desorption is herein meant to include VOC decomposition. The VOC adsorption rotor 10 has a rotational speed of, for example, 8.4 rph to 11.0 rph.

The VOC removal method according to the embodiment includes the steps of: by passing the process gas through the adsorption zone Z1, adsorbing a VOC contained in the process gas; by passing a gaseous substance through the desorption zone Z2, desorbing the VOC adsorbed in the adsorption zone Z1; and in the cooling zone Z3, cooling the cellular structure 1 heated in the desorption zone Z2. The cellular structure 1 is made of metal, and in the desorption zone Z2, the cellular structure 1 is heated by passage of current through the cellular structure 1. Since the passage of current through the cellular structure 1 gives rise to Joule heat, the cellular structure 1 can be heated directly in the desorption zone Z2. This makes it possible to reduce the amount of energy required for VOC desorption in the desorption zone Z2.

That is, compared with the conventional method with which a VOC adsorbed on the cellular structure 1 is desorbed solely by passage of a heated gaseous substance through the desorption zone 22, the VOC removal method according to the embodiment provides improved heating efficiency, which allows the VOC adsorbed on the VOC adsorption rotor 10 to be desorbed with high energy efficiency.

Further, according to the above-mentioned method, the cellular structure 1 is heated by passage of current through the cellular structure 1, and also a heated gaseous substance is passed through the desorption zone Z2. As a result, the temperature to which to heat the gaseous substance to be passed through the desorption zone Z2 can be lowered, as compared with the conventional method mentioned above.

To pass current through the cellular structure 1 in the desorption zone Z2, for example, voltage may be applied to the cellular structure 1 in the desorption zone Z2. In that case, voltage may be applied to the cellular structure 1 in the desorption zone 22 from each outer side portion of the VOC adsorption rotor 10 in the direction in which the rotational axis 11 extends. The following describes how the voltage application device 30 illustrated in FIG. 1 applies voltage to the cellular structure 1 in the desorption zone Z2 from each outer side portion of the VOC adsorption rotor 10 in the direction in which the rotational axis 11 extends.

The pair of electrodes 20a and 20b are disposed one each at each outer side portion of the VOC adsorption rotor 10 in the direction in which the rotational axis 11 of the VOC adsorption rotor 10 extends, and are positioned in contact with the VOC adsorption rotor 10. The pair of electrodes 20aand 20b are preferably disposed at opposite positions in the direction in which the rotational axis 11 extends. The VOC adsorption rotor 10 has the adsorption zone Z1, the desorption zone Z2, and the cooling zone Z3 as described above, and the pair of electrodes 20a and 20b are disposed in the desorption zone Z2 of these zones. More specifically, as illustrated in FIGS. 1 and 2, the pair of electrodes 20a and 20b are each disposed at a position in the desorption zone Z2 near the adsorption zone Z1.

The pair of electrodes 20a and 20b are made of, for example, graphite. It is to be noted, however, that a suitable material for the pair of electrodes 20a and 20b is not limited to graphite but may be a metal such as copper.

According to the embodiment, the pair of electrodes 20a and 20b each have a shape that extends in the radial direction of the VOC adsorption rotor 10. The radially extending shape of each of the pair of electrodes 20a and 20b helps to ensure that when voltage is applied to the pair of electrodes 20a and 20b by the voltage application device 30 described later, a large region of the cellular structure 1 in the radial direction can be heated. Further, as illustrated in FIGS. 1 and 2, the pair of electrodes 20a and 20b each have an elongated shape. This helps to ensure that when a heated gaseous substance passes through the desorption zone Z2, the passage of the heated gaseous substance is not obstructed.

It is to be noted, however, that the shape of each of the pair of electrodes 20a and 20b is not limited to the shape as illustrated in FIGS. 1 and 2. For example, the pair of electrodes 20a and 20b may be in the shape of a roller whose surface in contact with the VOC adsorption rotor 10 is a rotary surface.

As described above, each of the pair of electrodes 20a and 20b is positioned in contact with the VOC adsorption rotor 10. Accordingly, as the VOC adsorption rotor 10 rotates, the VOC adsorption rotor 10 rubs against the pair of electrodes 20a and 20b while maintaining its contact therewith.

The voltage application device 30 is capable of applying voltage to the pair of electrodes 20a and 20b. For example, the voltage application device 30 applies voltage to the pair of electrodes 20a and 20b in such a way that the resulting output is 2 kW to 10 kW. The application of voltage to the pair of electrodes 20a and 20b by the voltage application device 30 allows current to pass through the cellular structure 1 made of metal in the desorption zone Z2. As a result, the cellular structure 1 can be heated directly.

As described above, voltage is applied to the cellular structure 1 in the desorption zone Z2 from each outer side portion of the VOC adsorption rotor 10 in the direction in which the rotational axis 11 extends. As a result, the cellular structure 1 can be heated efficiently in the direction in which the rotational axis 11 extends. Further, as described above, voltage is applied to the pair of electrodes 20a and 20b that are disposed one each at each outer side portion of the VOC adsorption rotor 10 in the direction in which the rotational axis 11 extends, and that are positioned in contact with the VOC adsorption rotor 10. As a result, voltage can be applied easily from each outer side portion of the VOC adsorption rotor 10 in the direction in which the rotational axis 11 extends.

The present disclosure is not limited to the embodiments mentioned above but allows various alterations and modifications to be made within the scope of the present disclosure. For example, although application of voltage to the cellular structure 1 is described above as an exemplary method for passing current through the cellular structure 1 made of metal in the desorption zone Z2, current may be passed through the cellular structure 1 by another method.

The foregoing description of the embodiment is directed to the example in which voltage is applied to the cellular structure 1 in the desorption zone Z2 from each outer side portion of the VOC adsorption rotor 10 in the direction in which the rotational axis 11 extends. Alternatively, however, voltage may be applied to another position of the cellular structure 1 in the desorption zone Z2.

Although the foregoing description of the embodiment is directed to the case where a gaseous substance for cooling the cellular structure 1 is passed through the cooling zone Z3 to thereby cool the cellular structure 1 in the cooling zone Z3, the cellular structure 1 may be cooled in the cooling zone Z3 by another method.

Although the foregoing description assumes that the VOC removal apparatus 100 includes a single pair of electrodes 20a and 20b disposed in the desorption zone Z2, in an alternative configuration, a plurality of such electrode pairs may be disposed in the desorption zone Z2, and voltage may be applied to the plurality of electrode pairs. In that case, a wide area of the cellular structure 1 can be heated at once in the desorption zone Z2.

### REFERENCE SIGNS LIST

1 cellular structure

2 cell

10 VOC adsorption rotor

11 rotational axis

20a, 20b pair of electrodes

30 voltage application device

41 first blowing device

42 second blowing device

43 third blowing device

44 heating device

100 VOC removal apparatus

Z1 adsorption zone

Z2 desorption zone

Z3 cooling zone

1. A VOC removal method comprising:
adsorbing a VOC contained in a process gas by passing the process gas through an adsorption zone of a VOC adsorption rotor that includes a cellular structure supporting an adsorbent to adsorb a VOC, wherein the cellular structure is made of metal;
desorbing the VOC adsorbed in the adsorption zone by heating the cellular structure by passing current through the cellular structure in a desorption zone of the VOC adsorption rotor and passing a gaseous substance through the desorption zone of the VOC adsorption rotor; and
cooling the cellular structure heated in the desorption zone in a cooling zone of the VOC adsorption rotor.

2. The VOC removal method according to claim 1, wherein in the desorption zone, the current is passed through the cellular structure by applying a voltage to the cellular structure.

3. The VOC removal method according to claim 2, wherein in the desorption zone, the voltage is applied to the cellular structure from each outer side portion of the VOC adsorption rotor in a direction in which a rotational axis of the VOC adsorption rotor extends.

4. The VOC removal method according to claim 3, wherein the voltage is applied to a pair of electrodes respectively located at each outer side portion of the VOC adsorption rotor in the direction in which the rotational axis of the VOC adsorption rotor extends, the pair of electrodes being positioned in contact with the VOC adsorption rotor.

5. The VOC removal method according to claim 1, wherein with respect to a direction of rotation of the VOC adsorption rotor, the adsorption zone occupies an angular range of 230° to 270°, the desorption zone occupies an angular range of 30° to 60°, and the cooling zone occupies an angular range of 30° to 60°.

6. The VOC removal method according to claim 1, wherein the process gas is passed through the adsorption zone by being blown with a first blowing device.

7. The VOC removal method according to claim 6, wherein the gaseous substance is passed through the desorption zone by being blown with a second blowing device.

8. The VOC removal method according to claim 7, wherein a gaseous substance for cooling the cellular structure is blown to the cooling zone by a third blowing device.

9. The VOC removal method according to claim 1, further comprising rotating the VOC adsorption rotor such that adsorption and desorption of the VOC contained in the process gas is performed repeatedly.
